(19) United States
(12) Patent Application Publication
(10) Pub. No.: US 2011/0236030 A1
(43) Pub. Date: Sep. 29, 2011

(54) OPTICAL INTERCONNECT AND SIGNAL TRANSMISSION METHOD

(75) Inventors: Zhenhua SHAO, Torrance, CA (US); Christopher Lee Keller, Torrance, CA (US); Masataka Ito, Torrance, CA (US); Dongdong Wang, Torrance, CA (US)

(73) Assignee: IBIDEN CO., LTD., Ogaki-shi (JP)

(21) Appl. No.: 13/012,252

(22) Filed: Jan. 24, 2011

Related U.S. Application Data
(60) Provisional application No. 61/318,082, filed on Mar. 26, 2010.

(51) Int. Cl. H04B 10/12; H04B 10/00

(52) U.S. Cl. 398/141; 398/154

(57) ABSTRACT

An optical interconnect includes a transmitter circuit, a receiver circuit and an optical signal transmission route. The transmitter circuit includes a control circuit and an electrical/optical converter circuit. The control circuit receives an input electrical signal and outputs a drive signal. The electrical/optical converter circuit includes a light emitting element and converts the drive signal to an optical signal. The receiver circuit includes an optical/electrical converter circuit and a data recovery circuit. The data recovery circuit includes a second trigger signal generator and a latch circuit. The optical/electrical converter circuit includes a light receiving element and a received-signal amplifying circuit. The light receiving element converts the optical signal from the light emitting element to an output current signal. The received-signal amplifying circuit converts the output current signal to a required digital voltage signal. The optical signal transmission route optically is connecting the transmitter circuit and the receiver circuit.

### CROSS-REFERENCE TO RELATED APPLICATIONS

The present application claims the benefits of priority to U.S. Application No. 61/318,082, filed Mar. 26, 2010. The contents of that application are incorporated herein by reference in their entirety.

### BACKGROUND OF THE INVENTION

1. Field of the Invention

The present invention relates to an optical interconnect and a method for transmitting signals.

2. Discussion of the Background

As for an optical signal transmission apparatus, the following is conventionally known: an optical signal transmission apparatus which has a light transmitting section, a light receiving section and an optical signal transmission route optically connecting the light transmitting section and the light receiving section (see, for example, Maxim white paper, 19-2194; Rev. 3; 5/04, and Maxim white paper, 19-2207; Rev. 1; 3/05). The light transmitting section is formed with a drive circuit to which an input electrical signal is input and which outputs a drive signal to drive a light emitting element, and with a light emitting element to which the drive signal is input and which outputs optical signals.

The light receiving section is formed with the following: a light receiving element to which an optical signal, generated in the light emitting element and transmitted through an optical-signal transmission route, is input and which converts the optical signal to an output current signal; a preamplifier circuit which converts the output current signal to output an output voltage signal; and a limiting amplifier circuit which amplifies the output voltage signal to a required digital signal level and outputs a digital voltage signal.

Signal transmission in such an optical signal transmission apparatus is carried out as follows: in the light transmitting section, the drive circuit changes the current for a drive signal according to the input electrical signal, and the light emitting element outputs an optical signal whose intensity is changed according to the drive signal; and the output optical signal is transmitted through the optical signal transmission route and is input to the light receiving section.

In the light receiving section, the light receiving element outputs an output current signal whose current is changed according to the received light intensity of the input optical signal, and the preamplifier circuit converts the output current signal to an output voltage signal whose voltage is changed accordingly. The output voltage signal converted in the preamplifier circuit is input to the limiting amplifier circuit and amplified to a required digital signal level, and then an output electrical signal is output.

FIG. 11 is a block diagram showing the structure of a conventional optical signal transmission apparatus. Conventional optical signal transmission apparatus 300 shown in FIG. 11 has the following: in light transmitting section 350, drive circuit 310 and light emitting element 320 as well as first logic circuit 330, which prepares control information, and light emitting intensity controller 340, which controls operations in drive circuit 310 according to the control information; and in light receiving section 400, light receiving element 370 and trans-impedance amplifier (TIA) circuit 360 as well as received-light intensity detector 380, which detects received light intensity in light receiving element 370, and second logic circuit 390, to which the received light intensity is input.

When signals are transmitted using optical signal transmission apparatus 300, input electrical signal 410 is converted to optical signal 430 by light emitting element 320 in light transmitting section 350. In light receiving section 400, optical signal 430 transmitted through optical signal transmission route 500 is input to light receiving element 370, and output current signal 440 is output. Output current signal 440 is converted to output electrical signal 420 in TIA circuit 360. Simultaneously, received-light intensity detector 380 detects the received light intensity of optical signal 430, and the information is transmitted to first logic circuit 330 through second logic circuit 390. Then, by comparing the detected value with a predetermined value of received light intensity, control information is prepared. The control information prepared in first logic circuit 330 is input to light emitting intensity controller 340, and light emitting intensity controller 340 controls operations in drive circuit 310 according to the control information. The light emitting intensity at light emitting element 320 is controlled to be the predetermined value.

When signals are transmitted in optical signal transmission apparatus 300 described in Japanese Laid-Open Patent Publication 2009-212812, emitted light intensity of optical signal 430 to be output next from light emitting element 320 is feedback-controlled to a predetermined value based on the emitted light intensity of optical signal 430, which was output by light emitting element 320 itself.

In the following, situations in which electrical/optical conversion is carried out in light transmitting section 350, and situations in which optical/electrical conversion is carried out in light receiving section 400 are described in detail by referring to FIG. 12.

FIG. 12 is a timing chart of an input electrical signal, an optical signal, an output current signal and an output electrical signal shown from the top in that order in an example when signals are transmitted using a conventional optical signal transmission apparatus.

In an example shown in FIG. 12, one bit of input electrical signal 410 is indicated as either high level or low level; “1” is assigned to a high-level input electrical signal, and “0” is assigned to a low-level input electrical signal. When one bit of high-level input electrical signal (410h) is input to light emitting element 320, light emitting element 320 is driven for a duration corresponding to the duration of high-level input electrical signal (410h), and one bit of high-level optical signal (430h) is output. Then, when one bit of high-level optical signal (430h) is input to light receiving element 370, light receiving element 370 is driven for a duration corresponding to the duration of high-level optical signal (430h), and one bit of high-level output current signal (440h) is output. One bit of high-level output current signal (440h) is converted to a voltage signal in TIA circuit 360, and one bit of high-level output electrical signal (420h) is output.

On the other hand, when one bit of low-level input electrical signal (410l) is input to light emitting element 320, light emitting element 320 halts its drive for a duration corresponding to the duration of low-level input electrical signal (410l), and one bit of low-level optical signal (430l) is output. Then, when one bit of low-level optical signal (430l) is input to light receiving element 370, light receiving element 370 and TIA circuit 360 halt their drive for a duration corresponding to the duration of low-level optical signal (430l), and one bit of low-level output electrical signal (420l) is output.

Accordingly, even if the emitted light intensity of optical signal 430 is kept low by using light emitting intensity controller 340 or the like, light emitting element 320, which consumes greater power, will continue to be driven in a duration of one bit while high-level input electrical signal (410h) is maintained. Also, in a duration of one bit while high-level optical signal (430h) is maintained, TIA circuit 360, which consumes greater power, will continue to be operated.

The contents of these publications are incorporated herein by reference in their entirety.

### SUMMARY OF THE INVENTION

According to one embodiment of the present invention, an optical interconnect includes a transmitter circuit, a receiver circuit and an optical signal transmission route optically connecting the transmitter circuit and the receiver circuit. The transmitter circuit includes a control circuit and an electrical/optical converter circuit. The control circuit receives an input electrical signal and outputs a drive signal. The electrical/optical converter circuit includes a light emitting element and converts the drive signal to an optical signal. The receiver circuit includes an optical/electrical converter circuit and a data recovery circuit. The data recovery circuit includes a second trigger signal generator and a latch circuit. The optical/electrical converter circuit includes a light receiving element and a received-signal amplifying circuit. The light receiving element converts the optical signal from the light emitting element of the transmitter circuit to an output current signal. The received-signal amplifying circuit converts the output current signal to a required digital voltage signal. The control circuit of the transmitter circuit receives the input electrical signal whose one bit is indicated as one of a high level and a low level. The control circuit of the transmitter circuit includes a first trigger signal generator and a data converter circuit. The first trigger signal generator receives the input electrical signal and generates a first trigger signal that is a clock pulse having a pulse width ½^{p} the pulse width of one bit of the input electrical signal and a ½^{p} duty ratio where p is a natural number of 1 or greater. The data converter circuit receives the input electrical signal and the first trigger signal and output the drive signal. The data converter circuit outputs a high-level drive signal only when a high-level signal of the (q)th-bit input electrical signal where q is a natural number of 1 or greater and a high-level signal of the first trigger signal are input, converts the high-level drive signal to a low-level drive signal, outputs the low-level drive signal when the high-level signal of the first trigger signal is switched to a low-level signal, and maintains the output of the low-level drive signal until a high-level signal of the input electrical signal and a high-level signal of the first trigger signal are input on or after the (q+1)th bit. The second trigger signal generator generates a second trigger signal which is a clock pulse having a pulse width ½^{r} the pulse width of one bit of the input electrical signal where r is a natural number of 1 or greater when the digital voltage signal is input. The latch circuit outputs a high-level output electrical signal only when a high-level signal of the (q)th-bit digital voltage signal and a high-level signal of the second trigger signal are input, and by maintaining the output of the high-level output electrical signal until a high-level signal of the (q+1)th-bit second trigger signal is input, converts the digital voltage signal to an output electrical signal having the same format as that of the input electrical signal.

According to another aspect of the present invention, a signal transmission method for transmitting signals using an optical interconnect having a transmitter circuit and a receiver circuit optically connected through an optical signal transmission route, includes: generating in the transmitter circuit a first trigger signal which is a clock pulse having a pulse width ½^{p} the pulse width of one bit of an input electrical signal that is input in the transmitter circuit and whose one bit is indicated as one of a high level and a low level, and having a ½^{p} duty ratio where p is a natural number of 1 or greater; outputting a high-level drive signal only when a high-level signal of the (q)th-bit input electrical signal where q is a natural number of 1 or greater and a high-level signal of the first trigger signal are input; transmitting an optical signal through the optical signal transmission route by driving a light emitting element using the high-level drive signal; switching the high-level drive signal to a low-level drive signal and outputting the low-level drive signal when the high-level signal of the first trigger signal is switched to a low-level signal; maintaining the output of the low-level drive signal until a high-level signal of the input electrical signal and a high-level signal of the first trigger signal are input on or after the (q+1)th bit; and halting transmission of the optical signal by halting the drive of the light emitting signal using the low-level drive signal. In the receiver circuit, the optical signal is converted to an output current signal at a light receiving element. The output current signal is converted to a required digital voltage signal. A second trigger signal, which is a clock pulse having a pulse width ½^{r} the pulse width of one bit of the input electrical signal where r is a natural number of 1 or greater, is generated. A high-level output electrical signal is output only when a high-level signal of the (q)th-bit digital voltage signal and a high-level signal of the second trigger signal are input. The digital voltage signal is converted to an output electrical signal having the same format as that of the input electrical signal by maintaining the output of the high-level output electrical signal until a high-level signal of the (q+1)th-bit second trigger signal is input.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram showing the structure of an optical interconnect according to an embodiment of the present invention;

FIG. 2(a) is a timing chart of a second input electrical signal, a first trigger signal and a drive signal in a transmitter circuit shown from the top in that order in an example when p=1, and FIG. 2(b) is an enlarged timing chart showing region “A” in FIG. 2(a);

FIG. 3(a) is a timing chart of a second digital voltage signal, a second trigger signal and an output electrical signal in a receiver circuit shown from the top in that order in an example when p=1 and r=1, and FIG. 3(b) is an enlarged timing chart showing region “B” in FIG. 3(a);

FIG. 4(a) is a perspective view schematically showing an optical interconnect according to the first embodiment, and FIG. 4(b) is a cross-sectional view taken at the “a-a” line of the optical interconnect shown in FIG. 4(a);

FIG. 5 is a circuit diagram showing an example of a latch circuit;

FIG. 6(a) is an enlarged timing chart of a second input electrical signal, a first trigger signal and a drive signal in a transmitter circuit shown from the top in that order in an example when p=2, and FIG. 6(b) is an enlarged timing chart of a second input electrical signal, clock pulse A, clock pulse B and first trigger signal shown from the top in that order in an example when p=2;

FIG. 7 is an enlarged timing chart of a second digital voltage signal, a second trigger signal and an output electrical signal in the receiver circuit shown from the top in that order in an example when p=2 and r=1;

FIG. 8(a) is an enlarged timing chart of a second input electrical signal, a first trigger signal and a drive signal in a transmitter circuit shown from the top in that order in an example when p=3, and FIG. 8(b) is an enlarged timing chart of a second input electrical signal, clock pulse A, clock pulse B, clock pulse C and a first trigger signal shown from the top in that order in an example when p=3;

FIG. 9 is an enlarged timing chart of a second digital voltage signal, a second trigger signal and an output electrical signal in a receiver circuit shown from the top in that order in an example when p=3 and r=1;

FIG. 10(a) is a perspective view schematically showing an optical interconnect according to the second embodiment, and FIG. 10(b) is a cross-sectional view taken at the “b-b” line of the optical interconnect in FIG. 10(a);

FIG. 11 is a block diagram showing the structure of a conventional optical signal transmission apparatus; and

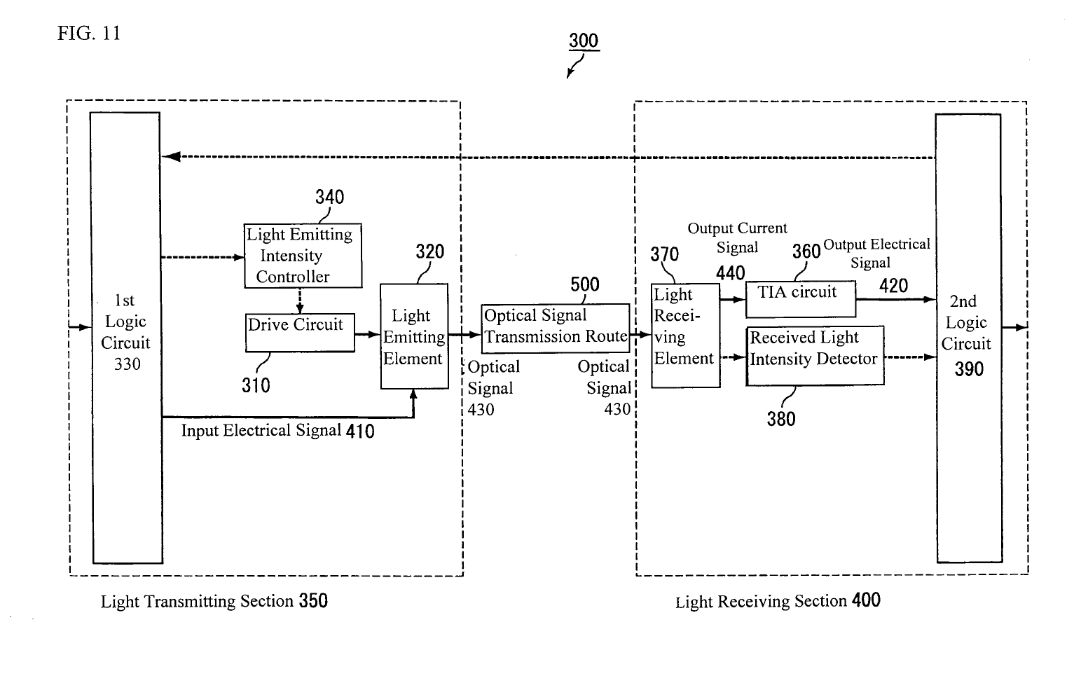

FIG. 12 is a timing chart of an input electrical signal, an optical signal, an output current signal and an output electrical signal shown from the top in that order in an example when signals are transmitted using a conventional optical signal transmission apparatus.

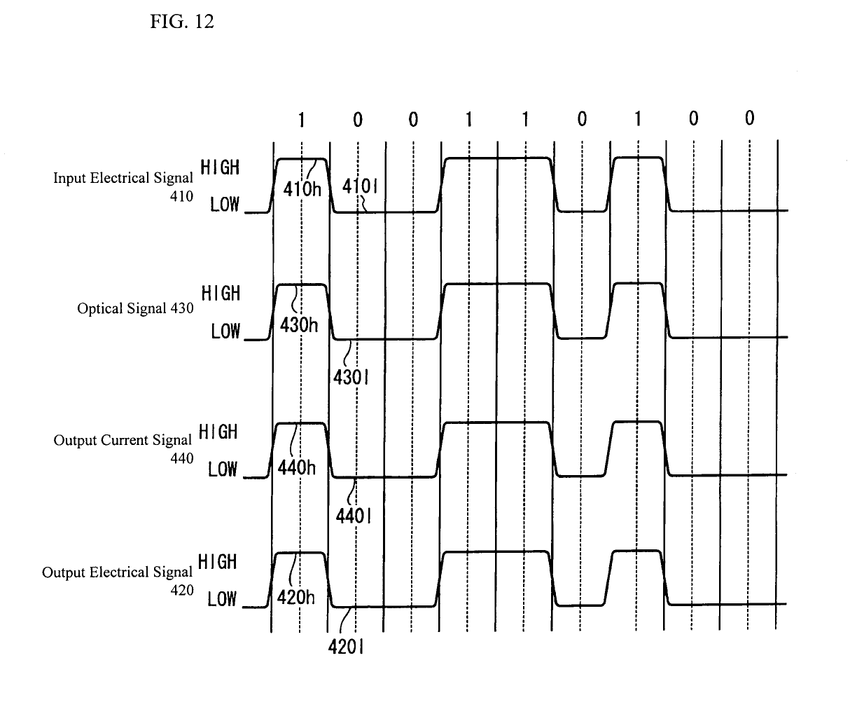

### DETAILED DESCRIPTION OF THE EMBODIMENTS

The embodiments will now be described with reference to the accompanying drawings, wherein like reference numerals designate corresponding or identical elements throughout the various drawings.

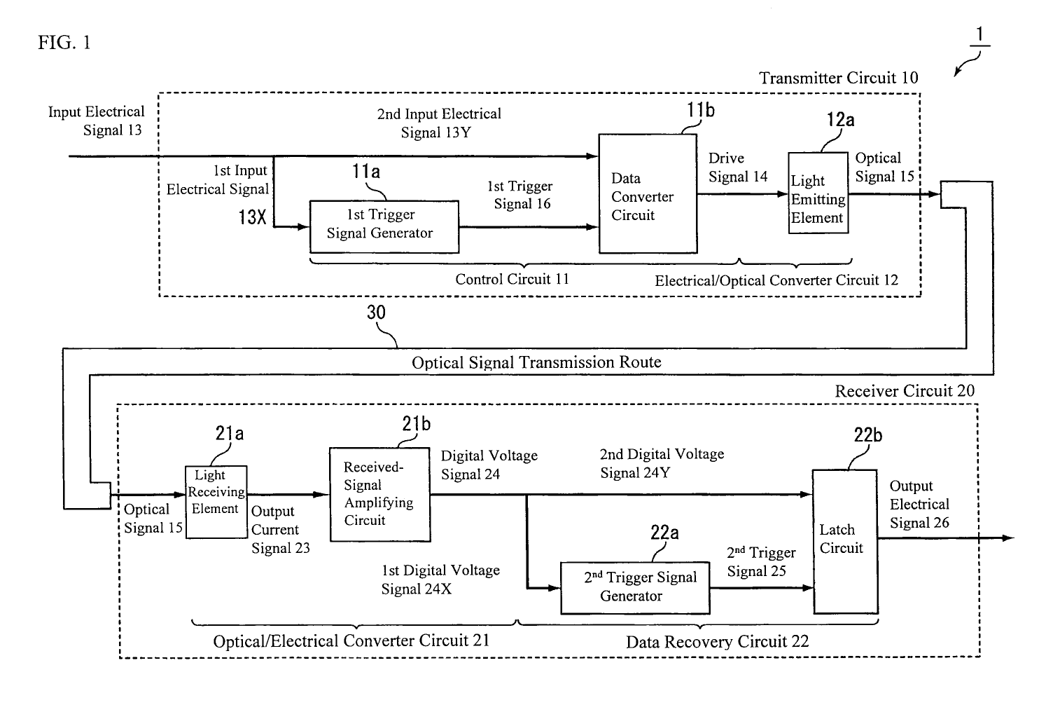

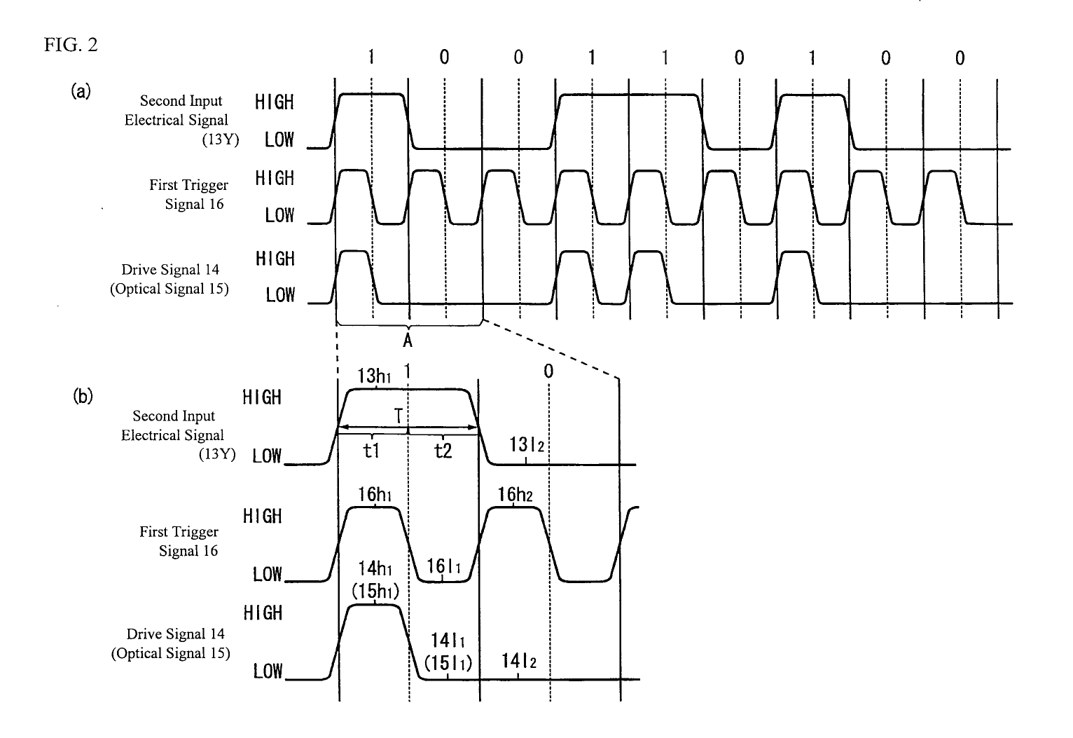

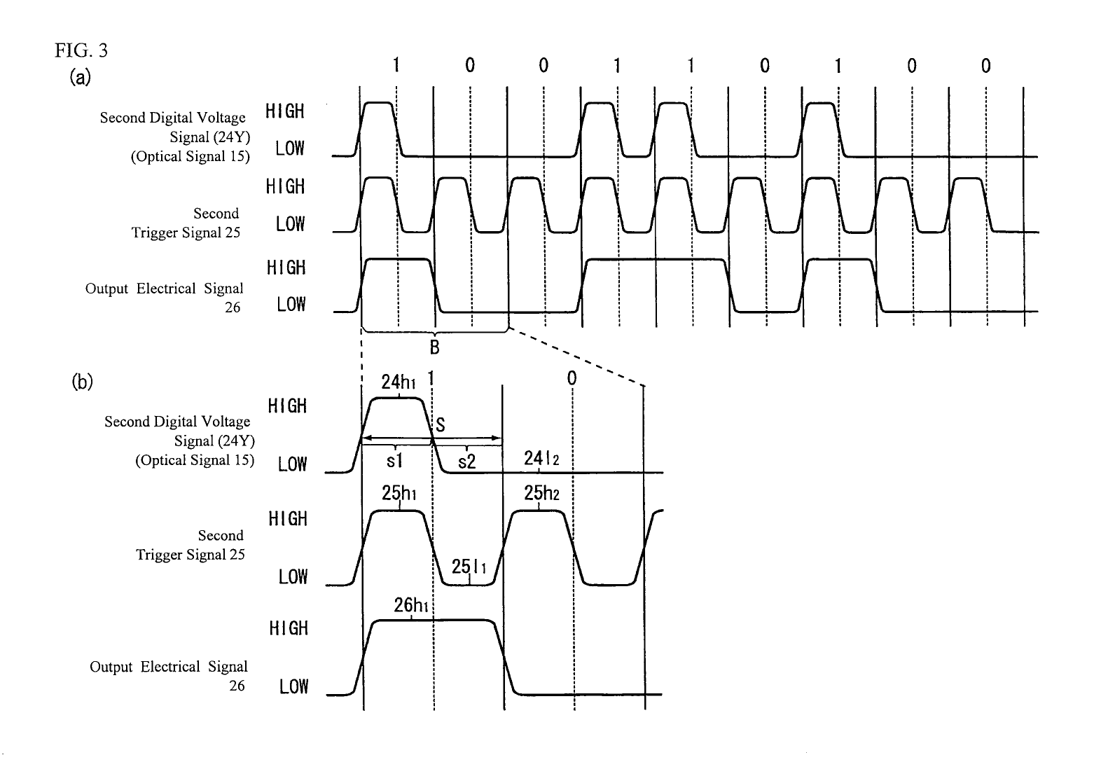

FIG. 1 is a block diagram showing the structure of an optical interconnect according to an embodiment of the present invention. FIG. 2(a) is a timing chart of a second input electrical signal, a first trigger signal and a drive signal in the transmitter circuit shown from the top in that order in an example when p=1; and FIG. 2(b) is an enlarged timing chart of region “A” shown in FIG. 2(a). FIG. 3(a) is a timing chart of a second digital voltage signal, a second trigger signal and an output electrical signal in the receiver circuit shown from the top in that order in an example when p=1 and r=1; and FIG. 3(b) is an enlarged timing chart of region “B” shown in FIG. 3(a).

Optical interconnect 1 according to an embodiment of the present invention shown in FIG. 1 has transmitter circuit 10, receiver circuit 20 and optical signal transmission route 30. Transmitter circuit 10 and receiver circuit 20 are optically connected by optical signal transmission route 30.

The structure of transmitter circuit 10 is described.

Transmitter circuit 10 of optical interconnect 1 shown in FIG. 1 has control circuit 11 to which input electrical signal 13 is input and from which drive signal 14 is output, and electrical/optical converter circuit 12 which is electrically connected to control circuit 11 and from which optical signal 15 is output toward optical signal transmission route 30.

Control circuit 11 has first trigger signal generator (11a) and data converter circuit (11b). In an example shown here, input electrical signal 13 is divided into first input electrical signal (13X) and second input electrical signal (13Y). First input electrical signal (13X) is input to first trigger signal generator (11a); and first trigger signal 16, which is output from first trigger signal generator (11a), and second input electrical signal (13Y) are input to data converter circuit (11b). Drive signal 14 which is output from data converter circuit (11b) is input to electrical/optical converter circuit 12 (light emitting element 12a).

First trigger signal generator (11a) generates first trigger signal 16, which is a clock pulse having a pulse width of ½^{p} the pulse width of one bit of first input electrical signal (13X) and having a duty ratio of ½^{p} (p is a natural number of 1 or greater).

Data converter circuit (11b) outputs drive signal 14 based on second input electrical signal (13Y) and first trigger signal 16. The specific operational method will be described later. Data converter circuit (11b) outputs a high-level drive signal only when a high-level signal of the (q)th-bit input electrical signal (q is a natural number of 1 or greater) and a high-level signal of the first trigger signal are input. When a high-level signal of the first trigger signal is switched to a low-level signal, the data converter circuit switches the high-level drive signal to a low-level drive signal, and maintains the output of the low-level drive signal until a high-level signal of the input electrical signal and a high-level signal of the first trigger signal are input on or after the (q+1)th bit.

The transmission method of optical signal 15 in transmitter circuit 10 is described by referring to FIGS. 1, 2(a) and 2(b). In an example shown in FIGS. 2(a) and 2(b), signals when p=1 are shown.

First, as shown in FIG. 1, first input electrical signal (13X), whose one bit is indicated as either a high level or a low level, is input to first trigger signal generator (11a).

At first trigger signal generator (11a), the frequency of first input electrical signal (13X) is detected. Then, as shown in FIGS. 2(a) and 2(b), first trigger signal 16 is generated, which is a clock pulse having a pulse width of ½ the pulse width of one bit of input electrical signal 13 (first and second input electrical signals) and having a duty ratio of ½. In the present specification, a pulse width corresponding to ½^{p} the pulse width of one bit of an input electrical signal is also simply referred to as a ½^{p} pulse width. Also, a duty ratio of ½^{p} is simply referred to as a ½^{p} duty ratio.

First trigger signal 16 generated at first trigger signal generator (11a) and second input electrical signal (13Y) are input to data converter circuit (11b) and compared.

Specifically, as shown in FIG. 2(b), when high-level signal (13h₁) of a 1st-bit second input electrical signal and high-level signal (16h₁) of a first trigger signal are input, high-level drive signal (14h₁) is output. Then, when high-level signal (16h₁) of the first trigger signal is switched to low-level signal (16l₁), high-level drive signal (14h₁) is switched to low-level drive signal (14l₁) and is output. After that, on or after the second bit, until a high-level signal of second input electrical signal (13Y) and a high-level signal of first trigger signal 16 are input, the output of low-level drive signals (14l₁, 14l₂) is maintained. Namely, as shown in FIG. 2(a), after the second bit until the fourth bit when a high-level signal of second input electrical signal (13Y) and a high-level signal of first trigger signal 16 are input, the output of low-level drive signal (14l₂) is maintained. On or after the fourth bit, drive signal 14 is output in the same manner as described above.

As described so far, second input electrical signal (13Y) which is input to data converter circuit (11b) is output as drive signal 14 having a ½ pulse width. As shown in FIG. 2(b), when a high-level signal of second input electrical signal (13Y) is input, while one bit of second input electrical signal (13Y) is maintained for duration (T), drive signal 14 is output as high-level drive signal (14h₁) for a duration corresponding to the first-half duration (t1) and is output as low-level drive signal (14l₁) for a duration corresponding to the latter-half duration (t2).

High-level drive signal (14h₁) which is output from control circuit 11 is input to electrical/optical converter circuit 12, light emitting element (12a) is driven for a duration corresponding to duration (t1), and high-level optical signal (15h₁) is output toward optical signal transmission route 30. Then, when low-level drive signal (14l₁) is input, light emitting element (12a) halts its drive for a duration corresponding to duration (t2), and low-level optical signal (15l₁) is output.

As described above, since control circuit 11 is arranged in transmitter circuit 10, the drive duration of light emitting element (12a) is reduced to half the duration of one bit. Accordingly, compared with a conventional transmitter circuit without control circuit 11, a sufficient decrease in power consumption is achieved.

Next, the structure of receiver circuit 20 is described. Receiver circuit 20 of optical interconnect 1 shown in FIG. 1 has optical/electrical converter circuit 21 and data recovery circuit 22.

Optical/electrical converter circuit 21 has light receiving element (21a) and received-signal amplifying circuit (21b).

Output current signal 23, which is output from light receiving element (21a), is input to received-signal amplifying circuit (21b), and digital voltage signal 24 which is output from received-signal amplifying circuit (21b) is input to data recovery circuit 22.

Light receiving element (21a) converts optical signal 15, which is output from light emitting element (12a) and transmitted through optical signal transmission route 30, to output current signal 23.

Received-signal amplifying circuit (21b) carries out current/voltage conversion of output current signal 23 which is output from light receiving element (21a), and then outputs digital voltage signal 24 by amplifying it to a required digital voltage signal level. Digital voltage signal 24 is input to data recovery circuit 22.

Data recovery circuit 22 has second trigger signal generator (22a) and latch circuit (22b). Digital voltage signal 24, which is output from received-signal amplifying circuit (21b), is divided into two. First digital voltage signal (24X) is input to second trigger signal generator (22a). Second trigger signal 25, which is output from second trigger signal generator (22a), and second digital voltage signal (24Y) are input to latch circuit (22b). Output electrical signal 26, which is output from latch circuit (22b), is connected to a predetermined external device which is not shown in the drawings.

Second trigger signal generator (22a) detects the frequency of first digital voltage signal (24X) and generates second trigger signal 25, which is a clock pulse having a pulse width of ½^{r} the pulse width of one bit of input electrical signal 13 (r is a natural number of 1 or greater).

Latch circuit (22b) outputs output electrical signal 26 based on second digital voltage signal (24Y) and second trigger signal 25. The specific operational method will be described later. Latch circuit (22b) outputs a high-level output electrical signal only when a high-level signal of the (q)th bit digital voltage signal and a high-level signal of the second trigger signal are input. Then, by maintaining the output of the high-level output electrical signal until a high-level signal of the (q+1)th second trigger signal is input, latch circuit (22b) converts the digital voltage signal to an output electrical signal having the same format as that of the input electrical signal.

Next, the method for receiving optical signal 15 in receiver circuit 20 is described with reference to FIGS. 1, 3(a) and 3(b). In an example shown in FIGS. 3(a) and 3(b), p=1 and r=1.

As shown in FIG. 1, optical signal 15 having a ½ pulse width transmitted through optical signal transmission route 30 is input to light receiving element (21a). When a high-level optical signal is input, a high-level output current signal is output from light receiving element (21a), and when a low-level optical signal is input, light receiving element (21a) halts its drive, and a low-level output current signal is output. Accordingly, output current signal 23 with a ½ pulse width is output from light receiving element (21a).

Output current signal 23 with a ½ pulse width, which is converted at light receiving element (21a), is converted and amplified to a required digital voltage signal in received-signal amplifying circuit (21b). Therefore, digital voltage signal 24 with a ½ pulse width is output from received-signal amplifying circuit (21b) (in FIG. 3(a), second digital voltage signal (24Y) is shown).

Therefore, compared with a situation in which a high-level optical signal is input for a duration of one bit and converted and amplified to a digital voltage signal, the running time of received-signal amplifying circuit (21b), which consumes greater power, is reduced in half. Accordingly, compared with a conventional optical/electrical converter circuit (receiver circuit), power consumption is sufficiently reduced.

At second trigger signal generator (22a), as shown in FIGS. 3(a) and 3(b), second trigger signal 25 is generated having a clock pulse with a ½ pulse width of one bit of input electrical signal 13. The duty ratio of second trigger signal 25 in the example shown here is set at ½. However, even if the duty ratio were to change a little because of wave distortion, the recovery of a digital voltage signal in the later-described latch circuit should not be a matter of concern.

Second trigger signal 25 and second digital voltage signal (24Y) are input to latch circuit (22b) and compared.

As shown in FIG. 3(b), since high-level signal (24h₁) of the 1st-bit second digital voltage signal and high-level signal (25h₁) of the second trigger signal are input, high-level signal (24h₁) of the second digital voltage signal is transferred to the output of latch circuit (22b). Therefore, in one-bit duration (S) of second digital voltage signal (24Y), high-level output electrical signal (26h₁) is output for a duration corresponding to the first-half duration (s1).

Then, when high-level signal (25h₁) of the second trigger signal is switched to low-level signal (25l₁), the output of high-level output electrical signal (26h₁) is maintained until high-level signal (25h₂) of the 2nd-bit second trigger signal is input. Namely, in one-bit duration (S) of second digital voltage signal (24Y), the output of high-level output electrical signal (26h₁) is maintained for a duration corresponding to the latter-half duration (s2).

As described above, high-level signal (24h₁) of the second digital voltage signal, which is input to latch circuit (22b), is output as output electrical signal (26h₁) which has a pulse width twice that of the high-level signal (24h₁) and which continues for a duration corresponding to one-bit duration (S). Here, one-bit duration (S) of second digital voltage signal (24Y) is equal to one-bit duration (T) of input electrical signal 13. That indicates digital voltage signal 24 is recovered to output electrical signal 26 having the same format as that of input electrical signal 13. Usually, power consumption of a latch circuit is sufficiently lower than that of a received-signal amplifying circuit where a preamplifier circuit, a limiting amplifier circuit and the like are integrated. Thus, power consumption while recovering a digital voltage signal to the same format as that of the input electrical signal in the latch circuit is extremely low compared with situations in which an output current signal, which is output without using a data converter circuit and whose pulse width is not reduced to a ½^{P}, is converted and amplified in a received-signal amplifying circuit.

As described so far, in an optical interconnect according to an embodiment of the present invention, power consumption is reduced in a transmitter circuit as well as a receiver circuit. Such an optical interconnect is especially suitable for achieving effects such as reduced power consumption even when signal transmission time is extended.

In an optical interconnect according to an embodiment of the present invention, it is preferred that the pulse width of the above first trigger signal be ½ the pulse width of one bit of the above input electrical signal and its duty ratio be set at ½, because of the reasons described above.

In an optical interconnect according to an embodiment of the present invention, it is preferred that the pulse width of the above first trigger signal be ¼ the pulse width of one bit of the above input electrical signal and that its duty ratio be set at ¼.

Furthermore, it is preferred that an optical interconnect according to an embodiment of the present invention have a flexible substrate and that the above optical signal transmission route be arranged on the flexible substrate.

Moreover, it is preferred that an optical interconnect according to an embodiment of the present invention have a flexible substrate and that the above optical signal transmission route, the transmitter circuit and the receiver circuit be arranged on the flexible substrate.

The signal transmission method according to an embodiment of the present invention is a signal transmission method for transmitting signals using an optical interconnect having a transmitter circuit and a receiver circuit optically connected through an optical signal transmission route. The transmitter circuit of such a transmitting method is characterized by the following: generating a first trigger signal which is a clock pulse having a pulse width ½^{p} the pulse width of one bit of an input electrical signal that is input in the transmitter circuit and whose one bit is indicated as either high level or low level, and having a ½^{p} duty ratio (p is a natural number of 1 or greater); outputting a high-level drive signal only when a high-level signal of the (q)th-bit input electrical signal (q is a natural number of 1 or greater) and a high-level signal of the first trigger signal are input; by driving a light emitting element using the high-level drive signal, transmitting an optical signal through the optical signal transmission route; when the high-level signal of the first trigger signal is switched to a low-level signal, switching the high-level drive signal to a low-level drive signal and outputting the low-level drive signal; maintaining the output of the low-level drive signal until a high-level signal of the input electrical signal and a high-level signal of the first trigger signal are input on or after the (q+1)th bit; and halting transmission of the optical signal by halting the drive of the light emitting signal using the low-level drive signal. Also, the receiver circuit is characterized by the following: converting the optical signal to an output current signal in a light receiving element; converting the output current signal to a required digital voltage signal; generating a second trigger signal, which is a clock pulse having a pulse width ½^{r} the pulse width of one bit of the input electrical signal (r is a natural number of 1 or greater); outputting a high-level output electrical signal only when a high-level signal of the (q)th-bit digital voltage signal and a high-level signal of the second trigger signal are input; and by maintaining the output of the high-level output electrical signal until a high-level signal of the (q+1)th-bit second trigger signal is input, converting the digital voltage signal to an output electrical signal having the same format as that of the input electrical signal.

According to a signal transmission method according to an embodiment of the present invention, power consumption is reduced. Since the reasons for that have been already described in the structure and effects of an optical interconnect according to an embodiment of the present invention, further description will be omitted here.

In a signal transmission method according to an embodiment of the present invention, it is preferred to generate a first trigger signal whose pulse width is ½ the pulse width of one bit of the above input electrical signal and to set its duty ratio at ½.

In a signal transmission method according to an embodiment of the present invention, it is preferred to generate a first trigger signal whose pulse width is ¼ the pulse width of one bit of the above input electrical signal and to set its duty ratio at ¼.

In a signal transmission method according to an embodiment of the present invention, it is further preferred that an optical interconnect have a flexible substrate and that the above optical signal transmission route be arranged on the flexible substrate.

Moreover, in a signal transmission method according to an embodiment of the present invention, it is preferred that an optical interconnect have a flexible substrate and that the above optical signal transmission route, the transmitter circuit and the receiver circuit be arranged on the flexible substrate.

### First Embodiment

In the following, the first embodiment, which is an embodiment of an optical interconnect and a signal transmission method of the present invention, is described with reference to the drawings.

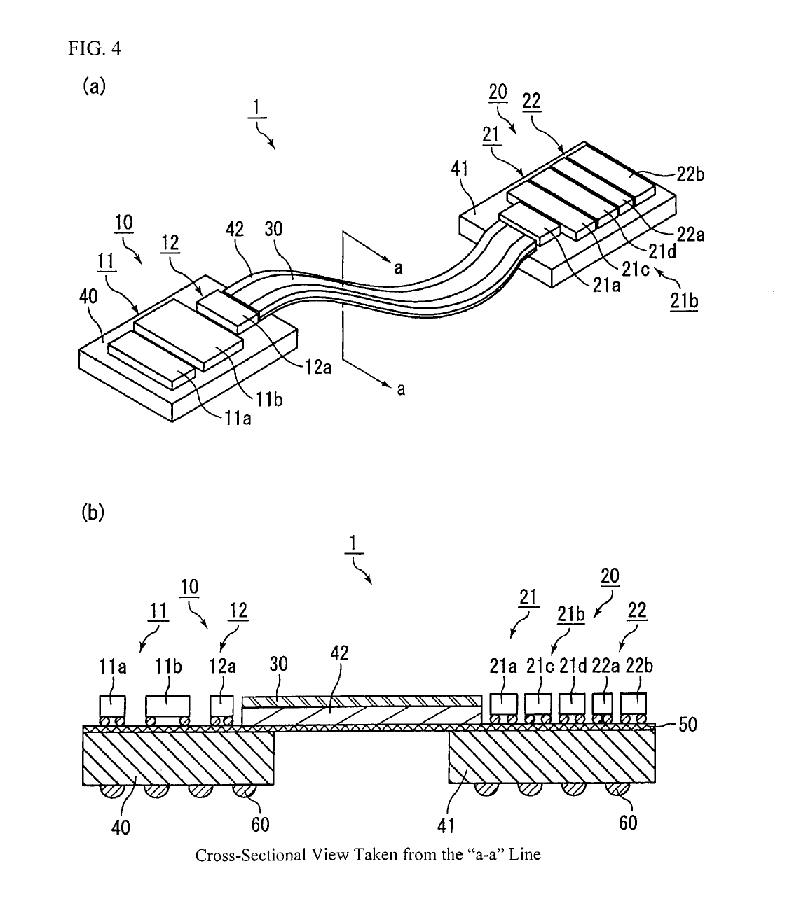

FIG. 4(a) is a perspective view schematically showing an optical interconnect according to the first embodiment, and FIG. 4(b) is a cross-sectional view taken from the “a-a” line of the optical interconnect shown in FIG. 4(a).

Optical interconnect 1 of the present embodiment shown in FIGS. 4(a) and 4(b) has first rigid substrate 40 with mounted transmitter circuit 10, second rigid substrate 41 with mounted receiver circuit 20, and optical signal transmission route 30 arranged on flexible substrate 42. First rigid substrate 40 and second rigid substrate 41 are connected to each other by flexible substrate 42; and first rigid substrate 40, flexible substrate 42 and second rigid substrate 41 are electrically connected by electrical wiring 50 formed on those substrates. Also, transmitter circuit 10 and receiver circuit 20 are optically connected through optical signal transmission route 30.

First rigid substrate 40 and second rigid substrate 41 may be the same type of rigid substrates, or they may be different types of rigid substrates. More specifically, as for a first rigid substrate or a second rigid substrate, various types of rigid substrates such as the following may be used: Bakelite substrates, glass-composite substrates, glass-epoxy substrates, Teflon substrates, alumina substrates, composite substrates, halogen-free substrates and the like. The first rigid substrate and the second rigid substrate are each connected to a mounting substrate such as a line card, not shown in the drawings, by electrical interface 60 made of a BGA formed on their bottom surfaces. As for electrical interface 60, detachable electrical connector terminals may also be used instead of BGAs.

As for flexible substrate 42, various flexible substrates such as a polyimide substrate may be used, for example.

As for optical signal transmission route 30, for example, sheet-type or board-type optical waveguides may be used. Also, optical signal transmission route 30 may be a waveguide sheet on which multiple optical waveguides are formed. As for an optical waveguide, for example, the following may also be used: an optical waveguide formed with a lower clad layer formed on a flexible substrate and made of epoxy polymer resin or the like, a core layer formed on the lower clad layer and made of epoxy polymer resin or the like with a higher reflective index than that of the lower clad layer, and an upper clad layer having the same composition as the lower clad layer.

Transmitter circuit 10 has control circuit 11 containing first trigger signal generator (11a) and data converter circuit (11b), and electrical/optical converter circuit 12 containing light emitting element (12a). Since their detailed structures have been already outlined above in the description of an optical interconnect according to an embodiment of the present invention, descriptions for redundant portions will be omitted here.

Light emitting element (12a) is a laser diode. An edge emitting laser diode, surface emitting laser diode or the like may be used. Among those, an edge emitting laser diode is preferred, because direct optical connection is achieved when a three-dimensional optical waveguide is used and optical wiring may be simplified compared with situations where a standard surface emitting laser diode is used.

First trigger signal generator (11a) contains a predetermined number of clock recovery circuits which generate clock pulses having a ½^{p} pulse width and a ½ duty ratio, and further contains a first AND circuit if required. As for a specific example of first trigger signal generator (11a) to be used when p=1, for example, a first trigger signal generator containing a clock recovery circuit which generates clock pulse A having a ½ pulse width and a ½ duty ratio based on the frequency of the input electrical signal may be used. As shown in FIG. 1, when first input electrical signal (13X) is input to first trigger signal generator (11a) containing the above structure, clock pulse A having a ½ pulse width and a ½ duty ratio is generated. Generated clock pulse A may be used as is for first trigger signal 16 in an example when p=1.

As for data converter circuit (11b), a second AND circuit may be used. As shown in FIGS. 2(a) and 2(b), when second input electrical signal (13Y) and first trigger signal 16 having a ½ pulse width and a ½ duty ratio are input to a second AND circuit, drive signal 14 having a ½ pulse width is output as a result of the AND operation of both signals. As for a first trigger signal generator or a data converter circuit, instead of the above-described AND circuit, an IC in which a NAND circuit, a NOR circuit and the like are integrated may also be used. In such a case, by properly arranging the NAND circuit and the like integrated in the IC, the circuits may be driven in the same manner as above.

The frequency of input electrical signal 13 is not limited to any specific number. For example, an input electrical signal having a frequency of 100 MHz-10 GHz may be used. In such a case, signal transmission may be carried out in a preferred manner by using an optical interconnect and a signal transmission method according to an embodiment of the present invention.

Receiver circuit 20 shown in FIGS. 4(a) and 4(b) has optical/electrical converter circuit 21 which contains light receiving element (21a) and received-signal amplifying circuit (21b), and data recovery circuit 22 which contains second trigger signal generator (22a) and latch circuit (22b). Since their detailed structures have been already outlined in a description of an optical interconnect according to an embodiment of the present invention, further descriptions of redundant portions will be omitted here.

Light receiving element (21a) is a photodiode, and an edge receiving photodiode, a surface receiving photodiode or the like may be used. Among those, an edge receiving photodiode is preferred, because direct optical connection is achieved when a three-dimensional optical waveguide is used, and optical wiring may be simplified compared with situations where a standard surface receiving photodiode is used.

Received-signal amplifying circuit (21b) has preamplifier circuit (21c) to convert an output current signal which is output from light receiving element (21a) to a voltage signal, and limiting amplifier circuit (21d) to output a digital voltage signal by amplifying the voltage signal which is output from preamplifier circuit (21c) to a required digital signal level.

Second trigger signal generator (22a) has a clock recovery circuit into which first digital voltage signal (24X) having a ½P pulse width is input and which generates a clock pulse having a ½P pulse width and a ½ duty ratio based on first digital voltage signal (24X). Furthermore, the second trigger signal generator has a frequency divider (multiplier) to amplify the pulse width of the clock pulse generated in the above clock recovery circuit to a predetermined power such as the power of (p). As a specific example for second trigger signal generator (22a) to be used when p=1, for example, the following may be listed: a second trigger signal generator, containing a clock recovery circuit into which first digital voltage signal (24X) is input, and which generates a clock pulse having a ½ pulse width and a ½ duty ratio. When first digital voltage signal (24X) having a ½ pulse width is input to the above second trigger signal generator (22a), a clock pulse having a ½ pulse width and a ½ duty ratio is generated in the clock recovery circuit. The generated clock pulse may be used as is for second trigger signal 25 when r=1 as shown in FIGS. 3(a) and 3(b).

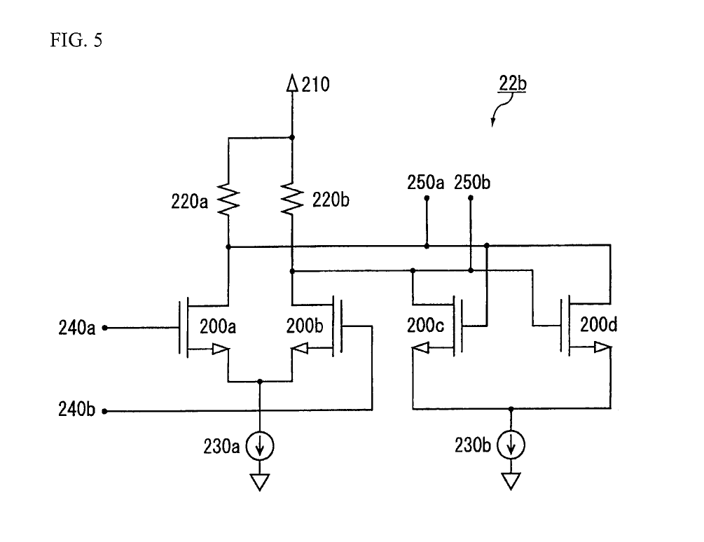

As latch circuit (22b), for example, a latch circuit with a structure shown in FIG. 5 may be used.

FIG. 5 is a circuit diagram showing an example of a latch circuit.

Latch circuit (22b) shown in FIG. 5 has four MOSFETs (200a-200d), power-source voltage 210, two resistors (220a, 220b), two power-source currents (230a, 230b), two input terminals (240a, 240b) and two output terminals (250a, 250b).

In a signal transmission method using an optical interconnect of the present embodiment, power consumption is reduced. The details have been outlined in a description of an optical interconnect according to an embodiment of the present invention in an example when p=1 and r=1. Here, an example is described with reference to the drawings using a first trigger signal (p=2) having a pulse width ¼ the pulse width of one bit of an input electrical signal and a ¼ duty ratio, and using a second trigger signal (r=1) having a pulse width ½ the pulse width of one bit of the input electrical signal. In the following example, the 1st-bit input electrical signal and the 2nd-bit input electrical signal are both high level.

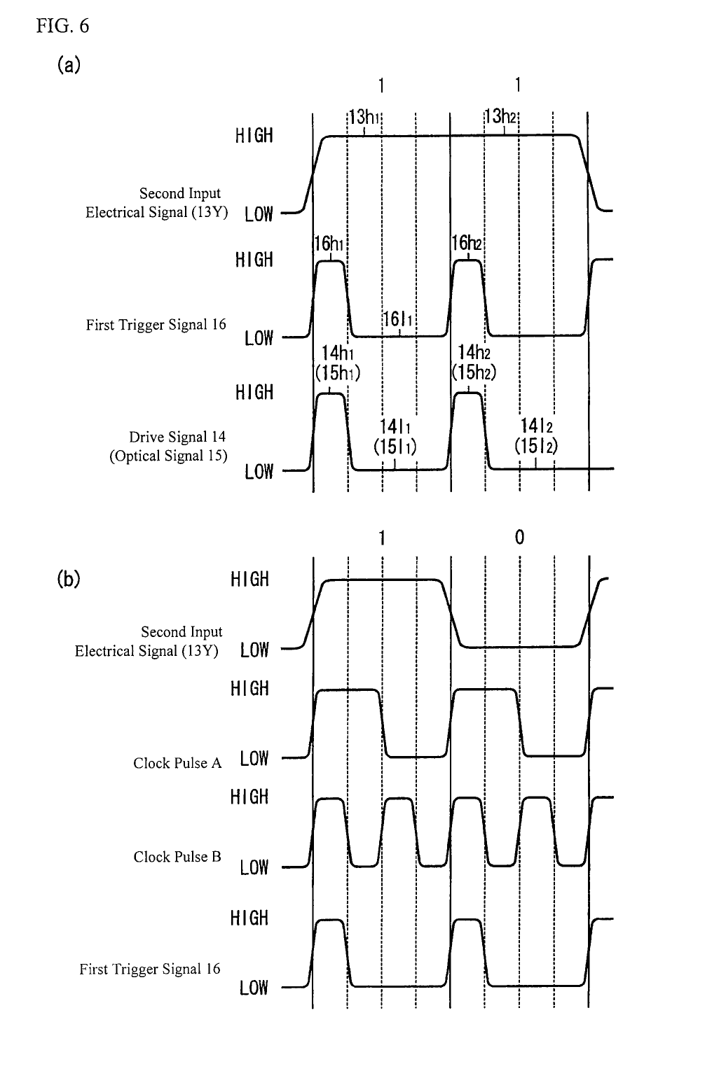

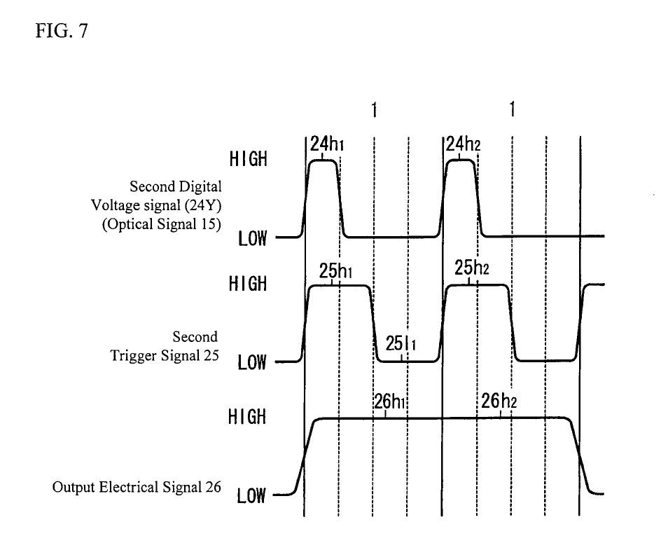

FIG. 6(a) is an enlarged timing chart of a second input electrical signal, a first trigger signal and a drive signal in a transmitter circuit shown from the top in that order in an example when p=2; FIG. 6(b) is an enlarged timing chart of a second input electrical signal, clock pulse A, clock pulse B and a first trigger signal shown from the top in that order in an example when p=2. FIG. 7 is an enlarged timing chart of a second digital voltage signal, a second trigger signal and an output electrical signal in a receiver circuit shown from the top in that order in an example when p=2 and r=1.

Optical signal transmission in a transmitter circuit is carried out as follows. First, signal transmission is described when the 1st-bit input electrical signal is input to a control circuit.

When first input electrical signal (13X) is input to first trigger signal generator (11a), based on its frequency, first trigger signal 16 having a ¼ pulse width and a ¼ duty ratio is generated as shown in FIG. 6(a).

First trigger signal 16 is generated by using first trigger signal generator (11a), which is structured with a first clock recovery circuit to generate the above clock pulse A, a second clock recovery circuit to generate clock pulse B, and a first AND circuit, and where clock pulse A and clock pulse B are input to the first AND circuit. The second clock recovery circuit is a frequency divider (multiplier), which generates clock pulse B whose frequency is twice that of clock pulse A.

In the following, a method for generating first trigger signal 16 is described by referring to FIG. 6(b).

As shown in FIG. 6(b), clock pulse A having a ½ pulse width and a ½ duty ratio is generated in a first clock recovery circuit; and clock pulse B having a ¼ pulse width and a ½ duty ratio is generated in a second clock recovery circuit. When an AND operation is conducted on both pulses in a first AND circuit, first trigger signal 16 having a ¼ pulse width and a ¼ duty ratio is generated (namely, first trigger signal 16 is a high-level signal for a duration corresponding to the first quarter of a one-bit duration and a low-level signal for a duration corresponding to the latter three quarters of the one-bit duration).

In data converter circuit (11b), first trigger signal 16 and second input electrical signal (13Y) are compared. If a second AND circuit is used as data converter circuit (11b), as shown in FIG. 6(a), when high-level signal (13h₁) of the 1st-bit second input electrical signal and high-level signal (16h₁) of the first trigger signal, high-level drive signal (14h₁) is output as a result of the AND operation. Then, when high-level signal (16h₁) of the first trigger signal is switched to low-level signal (16l₁), high-level drive signal (14h₁) is switched to low-level drive signal (14l₁) which is then output. After that, until a high-level signal of second input electrical signal (13Y) and a high-level signal of first trigger signal 16 are input on or after the second bit, the output of low-level drive signal (14l₁) is maintained. Accordingly, the 1st-bit second input electrical signal (13h₁), which is input to data converter circuit (11b), is output as drive signal 14 (14h₁ and 14l₁) having a ¼ pulse width.

When drive signal 14 having a ¼ pulse width is input to electrical/optical converter circuit 12, light emitting element (12a) is driven for a duration corresponding to the first ¼ of a one-bit duration, and high-level optical signal (15h₁) is output toward optical signal transmission route 30. After that, since low-level drive signal (14l₁) is input, light emitting element (12a) halts its drive for a duration corresponding to the latter ¾ of the one-bit duration, and low-level optical signal (15l₁) is output.

Therefore, when drive signal 14 is input to electrical/optical converter circuit 12, optical signal 15 (15h₁, 15l₁) having a ¼ pulse width is output from light emitting element (12a).

When the 2nd-bit input electrical signal (13h₂) is input to data converter circuit (11b), the same process is also carried out as when the above-described 1st-bit input electrical signal (13h₁) is input to data converter circuit (11b). Therefore, the 2nd-bit input electrical signal (13h₂) is output as drive signal 14 (14h₂ and 14l₂) having a ¼ pulse width by being compared with high-level signal (16h₂) of the 2nd-bit first trigger signal in data converter circuit (11b). Then, when drive signal 14 (14h₂ and 14l₂) is input to electrical/optical converter circuit 12, optical signal 15 (15h₂ and 15l₂) having a ¼ pulse width is output from light emitting element (12a).

Optical signal reception in a receiver circuit is carried out as follows. First, signal reception is described when an optical signal corresponding to the 1st-bit input electrical signal is input to an optical/electrical converter circuit.

As shown in FIG. 1, when optical signal 15 with a ¼ pulse width is input to light receiving element (21a), output current signal 23 is output from light receiving element (21a), having the same waveform as that of optical signal 15. Output current signal 23 passes through received-signal amplifying circuit (21b) (preamplifier circuit (21c) and limiting amplifier circuit (21d)), and digital voltage signal 24 having a ¼ pulse width is output.

In second trigger signal generator (22a), second trigger signal 25, which is a clock pulse with a pulse width ½ the pulse width of one bit of the input electrical signal, is generated based on first digital voltage signal (24X) divided from digital voltage signal 24.

Second trigger signal 25 is generated by using second trigger signal generator (22a), having a clock recovery circuit to which first digital voltage signal (24X) is input and which generates a clock pulse having a ¼ pulse width and a ½ duty ratio, and a frequency divider (multiplier) which sets the pulse width of the clock pulse generated in the above clock recovery circuit to be twice as wide. When first digital voltage signal (24X) is input to the above second trigger signal generator (22a), second trigger signal 25 with a ½ pulse width is generated by generating a clock pulse with a ¼ pulse width and a ½ duty ratio in the clock recovery circuit and by setting the pulse width of the generated clock pulse to be twice as wide at the frequency divider (multiplier).

In latch circuit (22b), second digital voltage signal (24Y) and second trigger signal 25 are compared. As shown in FIG. 7, since high-level signal (24h₁) of the 1st-bit second digital voltage signal and high-level signal (25h₁) of the second trigger signal are input to latch circuit (22b), high-level signal (24h₁) of the second digital voltage signal is transferred, and high-level output electrical signal (26h₁) is output. Then, when high-level signal (25h₁) of the second trigger signal is switched to low-level signal (25l₁), high-level output electrical signal (26h₁) is maintained until high-level signal (25h₂) of the 2nd-bit second trigger signal is input. Therefore, second digital voltage signal (24Y) is output as output electrical signal 26 having a pulse width four times as wide as its own. Namely, second digital voltage signal (24Y) is converted to output electrical signal 26 having the same waveform as that of second input electrical signal (13Y), and is recovered to the same format as that of second input electrical signal (13Y).

When the 2nd-bit optical signal 15 (15h₂, 15l₂) is input to receiver circuit 20, the same process is conducted as when the above-described 1st-bit optical signal 15 (15h₁, 15l₁) is input to receiver circuit 20. Accordingly, output current signal 23 based on optical signal 15 is converted and amplified while it maintains a ¼ pulse width, and is output as second digital voltage signal (24h₂) shown in FIG. 7. Then, the 2nd-bit second digital voltage signal (24h₂) is output as output electrical signal (26h₂) with a pulse width four times as wide as its own by being compared with high-level signal (25h₂) of the 2nd-bit second trigger signal in latch circuit (22b).

Next, signal transmission is described as follows with reference to the drawings, using a first trigger signal (p=3) having a pulse width ⅛ the pulse width of one bit of an input electrical signal and a ⅛ duty ratio, and using a second trigger signal (r=1) having a pulse width ½ the pulse width of one bit of the input electrical signal. In the following example, signal transmission is described when the 1st-bit input electrical signal is high level, and the 2nd-bit input electrical signal is low level.

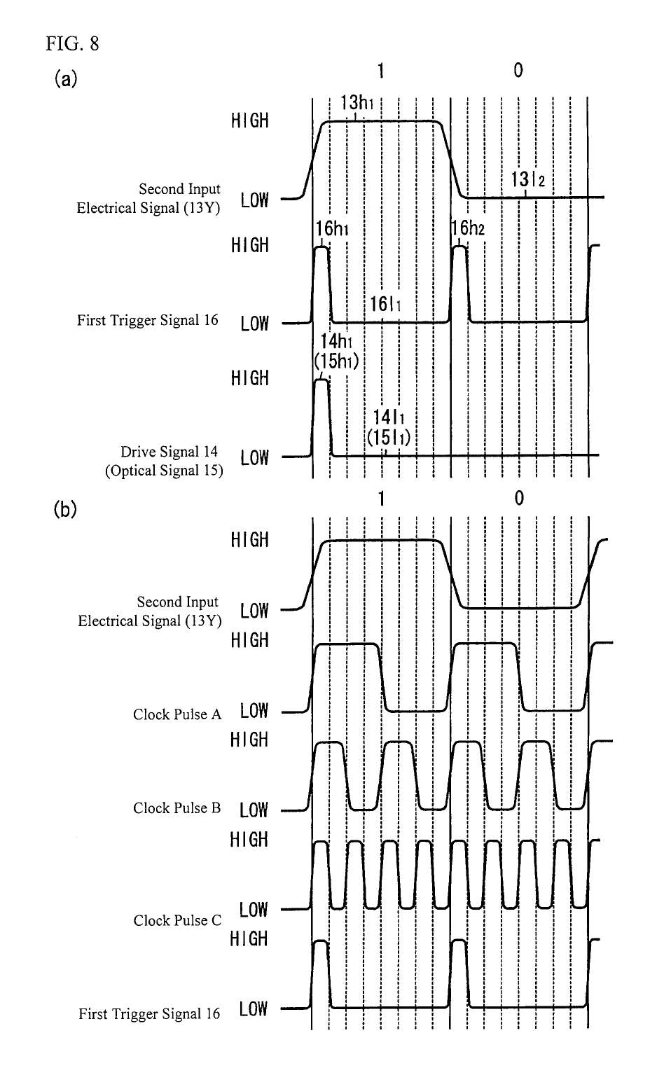

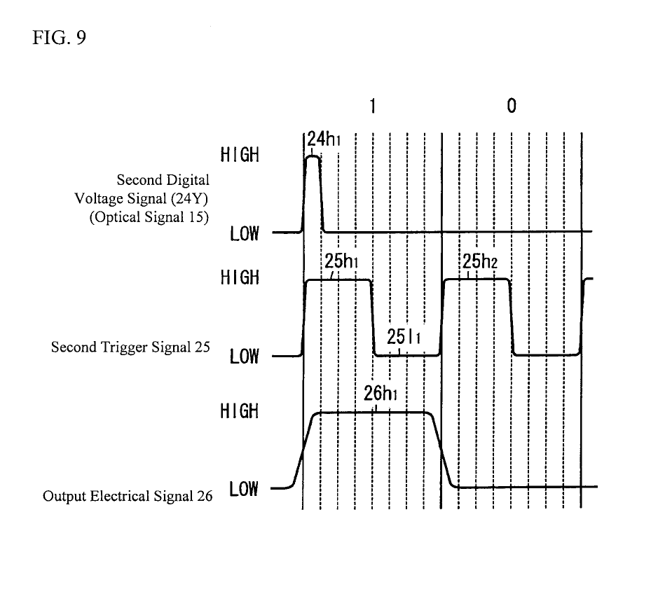

FIG. 8(a) is an enlarged timing chart of a second input electrical signal, a first trigger signal and a drive signal in a transmitter circuit shown from the top in that order in an example when p=3. FIG. 8(b) is an enlarged timing chart of a second input electrical signal, clock pulse A, clock pulse B, clock pulse C and first trigger signal shown from the top in that order in an example when p=3. FIG. 9 is an enlarged timing chart of a second digital voltage signal, a second trigger signal, and an output electrical signal in a receiver circuit shown from the top in that order in an example when p=3 and r=1.

Optical signal transmission in a transmitter circuit is conducted as follows. When first input electrical signal (13X) is input to first trigger signal generator (11a), based on its frequency, first trigger signal 16 with a ⅛ pulse width and a ⅛ duty ratio is generated as shown in FIG. 8(a).

First trigger signal 16 is generated by using a first trigger signal generator (11a) which is structured with a first clock recovery circuit to generate the above clock pulse A, a second clock recovery circuit to generate clock pulse B, and a third clock recovery circuit to generate clock pulse C, where clock pulses (A, B, C) are input to a first AND circuit. Such a process is described below with reference to FIG. 8(b). Second and third clock recovery circuits are both frequency dividers (multipliers); the second clock recovery circuit generates clock pulse B with a frequency twice that of clock pulse A, and the third clock recovery circuit generates clock pulse C with a frequency four times that of clock pulse A.

As shown in FIG. 8(b), clock pulse A with a ½ pulse width and a ½ duty ratio is generated in the first clock recovery circuit, clock pulse B with a ¼ pulse width and a ½ duty ratio is generated in the second clock recovery circuit, and clock pulse C with a ⅛ pulse width and a ½ duty ratio is generated in the third clock recovery circuit.

When an AND operation is conducted on those three clock pulses (A, B, C) in the first AND circuit, first trigger signal 16 with a ⅛ pulse width and a ⅛ duty ratio is generated (namely, first trigger signal 16 is a high-level signal for a duration corresponding to the first ⅛ of a one-bit duration and is a low-level signal for a duration corresponding to the latter ⅞ of the one-bit duration.)

In data converter circuit (11b), first trigger signal 16 and second input electrical signal (13Y) are compared. If a second AND circuit is used as data converter circuit (11b), as shown in FIG. 8(a), when high-level signal (13h₁) of the 1st-bit second input electrical signal and high-level signal (16h₁) of the first trigger signal are input, high-level drive signal (14h₁) is output as a result of the AND operation. Then, when high-level signal (16h₁) of the first trigger signal is switched to low-level signal (16l₁), high-level drive signal (14h₁) is switched to low-level drive signal (14l₁) which is then output. After that, until a high-level signal of second input electrical signal (13Y) and a high-level signal of first trigger signal 16 are input on or after the second bit, the output of low-level drive signal (14l₁) is maintained. Accordingly, the 1st-bit second input electrical signal (13h₁), which is input to data converter circuit (11b), is output as drive signal 14 (14h₁ and 14l₁) having a ⅛ pulse width.

When drive signal 14 having a ⅛ pulse width is input to electrical/optical converter circuit 12, light emitting element (12a) is driven for a duration corresponding to the first ⅛ of a one-bit duration, and high-level optical signal (15h₁) is output toward optical signal transmission route 30. After that, since low-level drive signal (14l₁) is input, light emitting element (12a) halts its drive for a duration corresponding to the latter ⅞ of the one-bit duration, and low-level optical signal (15e) is output. Therefore, optical signal 15 (15h₁, 15l₁) having a ⅛ pulse width is output from light emitting element (12a).

Optical signal reception in a receiver circuit is processed as follows.

As shown in FIG. 1, when optical signal 15 with a ⅛ pulse width is input to light receiving element (21a), output current signal 23 having the same waveform as that of optical signal 15 is output. Output current signal 23 passes through received-signal amplifying circuit (21b) (preamplifier circuit (21c) and limiting amplifier circuit (21d)), and digital voltage signal 24 with a ⅛ pulse width is output.

In second trigger signal generator (22a), second trigger signal 25, which is a clock pulse having a pulse width ½ the pulse width of one bit of the input electrical signal, is generated based on first digital voltage signal (24X) divided from digital voltage signal 24.

Second trigger signal 25 is generated by using second trigger signal generator (22a) containing the following: a clock recovery circuit which detects the frequency of first digital voltage signal (24X) and based on the detected frequency, which generates a clock pulse having a ⅛ pulse width and a ½ duty ratio; and a frequency divider (multiplier) which sets the pulse width of the clock pulse generated in the above clock recovery circuit to be four times as wide. When first digital voltage signal (24X) is input to the second trigger signal generator (22a), second trigger signal 25 with a ½ pulse width is generated by generating a clock pulse with a ⅛ pulse width and a ½ duty ratio in the clock recovery circuit based on its frequency, and by setting the pulse width of the generated clock pulse to be four times as wide in the frequency divider (multiplier).

In latch circuit (22b), second digital voltage signal (24Y) and second trigger signal 25 are compared. As shown in FIG. 9, since high-level signal (24h₁) of the 1st-bit second digital voltage signal and high-level signal (25h₁) of the second trigger signal are input to latch circuit (22b), high-level signal (24h₁) of the second digital voltage signal is transferred to the output of latch circuit (22b), and high-level output electrical signal (26h₁) is output. Then, when high-level signal (25h₁) of the second trigger signal is switched to low-level signal (25l₁), high-level output electrical signal (26h₁) is maintained until high-level signal (25h₂) of the 2nd-bit second trigger signal is input. Therefore, second digital voltage signal (24Y) is output as output electrical signal 26 having a pulse width eight times as wide as its own. Namely, second digital voltage signal (24Y) is converted to output electrical signal 26 with the same waveform as that of second input electrical signal (13Y), and is recovered to the same format as that of second input electrical signal (13Y).

As described above, in an optical interconnect and a signal transmission method according to the present embodiment, a predetermined control circuit is arranged in a transmitter circuit. Thus, the drive time of a light emitting element is reduced to ½^{p} of the one-bit duration of an input electrical signal. Also, in a receiver circuit, by a received-signal amplifying circuit (a preamplifier circuit and a limiting amplifier circuit), an output current signal is amplified to a digital voltage signal while maintaining the ½^{p} pulse width. Therefore, compared with signal transmission in which a received-signal amplifying circuit with greater power consumption is run for a duration of one bit, the running time of the received-signal amplifying circuit is reduced to ½^{p}. Accordingly, power consumption is sufficiently reduced. After that, since the digital voltage signal is converted to an output electrical signal with a pulse width the same as that of the input electrical signal, and is recovered to the same format as that of the input electrical signal, normal data transmission and reception are conducted.

### Second Embodiment

In the following, the second embodiment, which is an embodiment of an optical interconnect and a signal transmission method of the present invention, is described with reference to the drawings.

An optical interconnect of the present embodiment has the same structure as an optical interconnect of the first embodiment except that the optical signal transmission route, the transmitter circuit and the receiver circuit are arranged on a flexible substrate. Thus, descriptions of the portions redundant to those in an optical interconnect of the first embodiment are omitted here. Also, since a signal transmission method according to an embodiment of the present embodiment is the same as the signal transmission method described in the first embodiment except for using an optical interconnect according to an embodiment of the present embodiment, its description is omitted here.

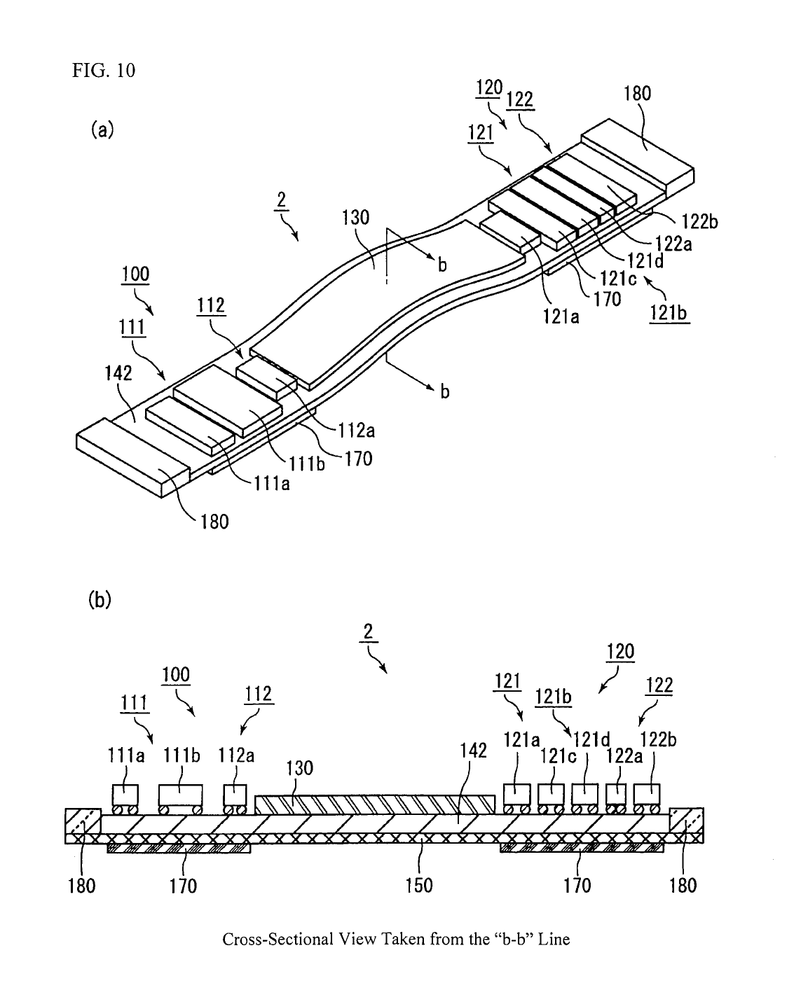

FIG. 10(a) is a perspective view schematically showing an optical interconnect of the second embodiment, and FIG. 10(b) is a cross-sectional view taken at the “b-b” line of the optical interconnect shown in FIG. 10(a).

Optical interconnect 2 of the present embodiment shown in FIGS. 10(a) and 10(b) has transmitter circuit 100, receiver circuit 120, optical-signal transmission route 130, and flexible substrate 142. Optical-signal transmission route 130, transmitter circuit 100 and receiver circuit 120 are arranged on single flexible substrate 142. Transmitter circuit 100 and receiver circuit 120 are electrically connected by electrical wiring 150 formed inside flexible substrate 142. Also, transmitter circuit 100 and receiver circuit 120 are optically connected by optical-signal transmission route 130.

Transmitter circuit 100 has control circuit 111 which contains first trigger signal generator (111a) and data converter circuit (111b), and electrical/optical converter circuit 112 which contains light emitting element (112a). Receiver circuit 120 has optical/electrical converter circuit 121 which contains light receiving element (121a) and received-signal amplifying circuit (121b) (preamplifier circuit (121c) and limiting amplifier circuit (121d)), and data recovery circuit 122 which contains second trigger signal generator (122a) and latch circuit (122b).

Optical-signal transmission route 130 may be arranged on flexible substrate 142 by means of another flexible substrate. Also, optical-signal transmission route 130 and flexible substrate 142 may be adhered to each other using an adhesive layer such as prepreg. Alternatively, by arranging a fixing member between optical-signal transmission route 130 and flexible substrate 142, space may be formed between optical-signal transmission route 130 and flexible substrate 142.

Of the main surfaces of flexible substrate 142, stiffener 170 is placed on a main surface opposite a surface where transmitter circuit 100 and receiver circuit 120 are arranged to reinforce the area where stiffener 170 is placed. Stiffener 170 is not always required to be placed.

Detachable electrical connector terminals 180, which are electrically connected to electrical wiring 150, are attached to both end portions of flexible substrate 142 as electrical interfaces.

Power consumption is reduced by using an optical interconnect and a signal transmission method according to the second embodiment, the same as in the first embodiment. Effects such as reduced power consumption are achieved in a preferred manner even when signal transmission time is extended.

### Another Embodiment

As for a second trigger signal to be used in an optical interconnect and a signal transmission method according to another embodiment of the present invention, it is preferred to use a clock pulse with a ½ pulse width as described above. When such a second trigger signal is used, even if the pulse width of a digital voltage signal is changed variously within a range of ½^{p} the pulse width of one bit of an input electrical signal (p is a natural number of 1 or greater), the digital voltage signal is recovered to an output electrical signal having the same format as that of the input electrical signal by inputting the digital voltage signal and the second trigger signal to a latch circuit. However, the waveform of the second trigger signal is not limited to having a ½ pulse width. It is sufficient if the waveform is such that the digital voltage signal is converted to an output electrical signal with the same format as that of the input electrical signal by inputting the digital voltage signal and the second trigger signal to a latch circuit. In particular, it is sufficient if the second trigger signal is a clock pulse having a pulse width of ½^{r} the pulse width of one bit of input electrical signal (r is a natural number of 1 or greater).

As for an example of a second trigger signal when r=2, the following may be used: a clock pulse having substantially the same waveform as first trigger signal 16, which has a ¼ pulse width and a ¼ duty ratio as shown in FIGS. 6(a) and 6(b).

As for an example of a second trigger signal when r=3, the following may be used: a clock pulse having substantially the same waveform as first trigger signal 16, which has a ⅛ pulse width and a ⅛ duty ratio as shown in FIGS. 8(a) and 8(b).

In other words, it is sufficient if a second trigger signal is a clock pulse whose rising timing of a high-level signal is synchronized with the rising timing of a high-level signal of the digital voltage signal, and which includes a high-level signal in a duration corresponding to a pulse width of one bit of the input electrical signal. Those second trigger signals may be generated by using, for example, a second trigger signal generator which contains a predetermined number of ICs such as a clock recovery circuit and an AND circuit, and which is structured to generate a clock pulse with a predetermined pulse width and duty ratio based on the input digital voltage signal.

By outputting drive signals with a narrower pulse width than the pulse width of input electrical signals, the drive time of a light emitting element decreases in comparison to the duration of high-level input electrical signals, and thus power consumption at a light transmitting section are reduced. Also, if output current signals with a narrower pulse width obtained by receiving optical signals at a light receiving element is amplified in a TIA circuit or the like, and then the pulse width is recovered to the same width as that of the input electrical signals using a latch circuit, which consumes extremely low power, then it is possible to shorten the running time of the TIA circuit or the like and to reduce power consumption in the light receiving section.

Namely, the optical interconnect according to an embodiment of the present invention is an optical interconnect having a transmitter circuit and a receiver circuit optically connected to each other through an optical signal transmission route. In such an optical interconnect, the transmitter circuit contains a control circuit to which an input electrical signal, whose one bit is indicated as either high level or low level, is input and which outputs a drive signal, and contains an electrical/optical converter circuit which includes a light emitting element to convert the drive signal to an optical signal; the control circuit contains a first trigger signal generator to which the input electrical signal is input and which generates a first trigger signal that is a clock pulse having a pulse width ½^{p} the pulse width of one bit of the input electrical signal and a ½^{p} duty ratio (p is a natural number of 1 or greater), and contains a data converter circuit to which the input electrical signal and the first trigger signal are input and which outputs the drive signal; the data converter circuit is structured so that it outputs a high-level drive signal only when a high-level signal of the (q)th-bit input electrical signal (q is a natural number of 1 or greater) and a high-level signal of the first trigger signal are input, converts the high-level drive signal to a low-level drive signal and outputs the low-level drive signal when the high-level signal of the first trigger signal is switched to a low-level signal, and maintains the output of the low-level drive signal until a high-level signal of the input electrical signal and a high-level signal of the first trigger signal are input on or after the (q+1)th bit; the receiver circuit contains an optical/electrical converter circuit and a data recovery circuit; the optical/electrical converter circuit contains a light receiving element in which an optical signal that is output from the light emitting element and transmitted through the optical signal transmission route is converted to an output current signal, and contains a received-signal amplifying circuit in which the output current signal is converted to a required digital voltage signal; the data recovery circuit contains a second trigger signal generator and a latch circuit; the second trigger signal generator is structured so that when the digital voltage signal is input, it generates a second trigger signal which is a clock pulse having a pulse width ½^{r} (r is a natural number of 1 or greater) the pulse width of one bit of the input electrical signal; and the latch circuit is structured so that it outputs a high-level output electrical signal only when a high-level signal of the (q)th-bit digital voltage signal and a high-level signal of the second trigger signal are input, and by maintaining the output of the high-level output electrical signal until a high-level signal of the (q+1)th-bit second trigger signal is input, it converts the digital voltage signal to an output electrical signal having the same format as that of the input electrical signal.

Obviously, numerous modifications and variations of the present invention are possible in light of the above teachings. It is therefore to be understood that within the scope of the appended claims, the invention may be practiced otherwise than as specifically described herein.

What is claimed is:

1. An optical interconnect, comprising:
a transmitter circuit comprising a control circuit and an electrical/optical converter circuit, the control circuit being configured to receive an input electrical signal and output a drive signal, the electrical/optical converter circuit comprising a light emitting element and being configured to convert the drive signal to an optical signal;
a receiver circuit comprising an optical/electrical converter circuit and a data recovery circuit, the data recovery circuit comprising a second trigger signal generator and a latch circuit, the optical/electrical converter circuit comprising a light receiving element and a received-signal amplifying circuit, the light receiving element is configured to convert the optical signal from the light emitting element of the transmitter circuit to an output current signal, the received-signal amplifying circuit being configured to convert the output current signal to a required digital voltage signal; and
an optical signal transmission route optically connecting the transmitter circuit and the receiver circuit,
wherein the control circuit of the transmitter circuit receives the input electrical signal whose one bit is indicated as one of a high level and a low level, the control circuit of the transmitter circuit is comprising a first trigger signal generator and a data converter circuit, the first trigger signal generator is configured to receive the input electrical signal and generate a first trigger signal that is a clock pulse having a pulse width ½^{p} the pulse width of one bit of the input electrical signal and a ½^{p} duty ratio where p is a natural number of 1 or greater, the data converter circuit is configured to receive the input electrical signal and the first trigger signal and output the drive signal, the data converter circuit is configured to output a high-level drive signal only when a high-level signal of the (q)th-bit input electrical signal where q is a natural number of 1 or greater and a high-level signal of the first trigger signal are input, to convert the high-level drive signal to a low-level drive signal, to output the low-level drive signal when the high-level signal of the first trigger signal is switched to a low-level signal, and to maintain the output of the low-level drive signal until a high-level signal of the input electrical signal and a high-level signal of the first trigger signal are input on or after the (q+1)th bit, the second trigger signal generator is configured to generate a second trigger signal which is a clock pulse having a pulse width ½^{r} the pulse width of one bit of the input electrical signal where r is a natural number of 1 or greater when the digital voltage signal is input, and the latch circuit is configured to output a high-level output electrical signal only when a high-level signal of the (q)th-bit digital voltage signal and a high-level signal of the second trigger signal are input, and by maintaining the output of the high-level output electrical signal until a high-level signal of the (q+1)th-bit second trigger signal is input, convert the digital voltage signal to an output electrical signal having a same format as a format of the input electrical signal.

2. The optical interconnect according to claim 1, wherein the first trigger signal has a pulse width ½ the pulse width of one bit of the input electrical signal and a ½ duty ratio.

3. The optical interconnect according to claim 1, wherein the first trigger signal has a pulse width ¼ the pulse width of one bit of the input electrical signal and a ¼ duty ratio.

4. The optical interconnect according to claim 1, further comprising a flexible substrate, wherein the optical signal transmission route is provided on the flexible substrate.

5. The optical interconnect according to claim 1, further comprising a flexible substrate, wherein the optical signal transmission route, the transmitter circuit and the receiver circuit are provided on the flexible substrate.

6. A signal transmission method for transmitting signals using an optical interconnect comprising a transmitter circuit and a receiver circuit optically connected through an optical signal transmission route, comprising:
generating in the transmitter circuit a first trigger signal which is a clock pulse having a pulse width ½^{p} the pulse width of one bit of an input electrical signal that is input in the transmitter circuit and whose one bit is indicated as one of a high level and a low level, and having a ½^{p} duty ratio where p is a natural number of 1 or greater;
outputting a high-level drive signal only when a high-level signal of the (q)th-bit input electrical signal where q is a natural number of 1 or greater and a high-level signal of the first trigger signal are input;
transmitting an optical signal through the optical signal transmission route by driving a light emitting element using the high-level drive signal;
switching the high-level drive signal to a low-level drive signal and outputting the low-level drive signal when the high-level signal of the first trigger signal is switched to a low-level signal;
maintaining the output of the low-level drive signal until a high-level signal of the input electrical signal and a high-level signal of the first trigger signal are input on or after the (q+1)th bit; and
halting transmission of the optical signal by halting the drive of the light emitting signal using the low-level drive signal,
wherein in the receiver circuit, the optical signal is converted to an output current signal at a light receiving element, the output current signal is converted to a required digital voltage signal, a second trigger signal, which is a clock pulse having a pulse width ½^{r} the pulse width of one bit of the input electrical signal where r is a natural number of 1 or greater, is generated, a high-level output electrical signal is output only when a high-level signal of the (q)th-bit digital voltage signal and a high-level signal of the second trigger signal are input, and the digital voltage signal is converted to an output electrical signal having a same format as a format of the input electrical signal by maintaining the output of the high-level output electrical signal until a high-level signal of the (q+1)th-bit second trigger signal is input.

7. The signal transmission method according to claim 6, further generating a first trigger signal having a pulse width ½ the pulse width of one bit of the input electrical signal and having a ½ duty ratio.

8. The signal transmission method according to claim 6, further generating a first trigger signal having a pulse width ¼ the pulse width of one bit of the input electrical signal and having a ¼ duty ratio.

9. The signal transmission method according to claim 6, wherein the optical interconnect further comprises a flexible substrate, and the optical signal transmission route is provided on the flexible substrate.

10. The signal transmission method according to claim 6, wherein the optical interconnect further comprises a flexible substrate, and the optical signal transmission route, the transmitter circuit and the receiver circuit are provided on the flexible substrate.
